(19) United States
(12) Patent Application Publication
(10) Pub. No.: US 2017/0255018 A1
(43) Pub. Date: Sep. 7, 2017

(54) AN APPARATUS AND METHOD FOR DISPLAYING AN OUTPUT FROM A DISPLAY

(71) Applicant: SELAFLEX LTD, Ashkelon (IL)

(72) Inventor: Ben-Zion Goldstein, New York, NY (US)

(21) Appl. No.: 15/509,130

(22) PCT Filed: Sep. 10, 2015
(86) PCT No.: PCT/IL2015/050929

§ 371 Date: Mar. 6, 2017

Related U.S. Application Data
(60) Provisional application No. 62/049,113, filed on Sep. 11, 2014.

(51) Int. Cl. G02B 27/01; A42B 3/04

(52) U.S. Cl. CPC G02B 27/0176; G02B 27/0172; G02B 27/0179; A42B 3/042; G02B 2027/0154; G02B 2027/013; G02B 2027/0156; G02B 2027/0169; G02B 2027/0181

(57) ABSTRACT

The present invention relates to a head-mountable visual accessory for displaying an image to a user from a portable display unit comprising: (a) a compartment for an image display unit; (b) at least one mirror for reflecting an image from said display unit; (c) adjustment means for adjusting the reflection of said image from said display unit to the eye of said user; (d) a structure for holding said at least one mirror, and said adjusting means for reflecting said image to said eye of the user of said visual accessory.

### TECHNICAL FIELD

The present invention relates to portable device accessories. More particularly, the present invention relates to portable display device accessories which enhance the user experience.

### BACKGROUND

As of today many audio accessories have been created for interfacing with a cellular phone including earphones and other kinds of hands free accessories. Typically, these accessories have been designed to allow the user hands free conversation when engaged in another activity such as driving, sports, home chores, etc.

In addition, head mounted displays which allow for the simultaneous viewing of visual information and/or images generated by computing devices and/or superimposed on a direct viewing of an external scene are also available today as well. Such head mounted displays find utility in many areas, such as training, machine control, or entertainment.

In some systems, the visual information or visual images are superimposed on an optical combiner mounted on the head gear, sometimes a helmet visor, in view of the eye of the wearer, i.e., the observer's line of sight. These visual images may be derived from a variety of display sources including cathode ray tubes, fiber optic displays, flat panel liquid crystal or electroluminescent devices, some including image enhancers, and even photographic projectors operating with an appropriate optical relay system, all of which may supply the observer with visual information.

U.S. Pat. No. 6,538,624 discloses a head-mounted image display apparatus for viewing an image formed by an image display means and virtually enlarged by an enlarging means while mounted on the head. The disclosed apparatus comprises an image display means; enlarging means; a frontal region support member, which is positioned at the frontal region when worn on the head; an occipital region support member, which is positioned at the occipital region; and securing means for holding the frontal region support member and the frontal region in contact when the main apparatus is worn on the head. Nevertheless, the disclosed apparatus is cumbersome.

It would therefore be desired to propose a system void of these deficiencies.

### SUMMARY

It is an object of the present invention to provide an apparatus for hands free view of a portable display.

It is another object of the present invention to provide an accessory for extending the visual display of a portable device.

It is still another object of the present invention to provide an apparatus for enhancing the user experience of a portable display device.

Other objects and advantages of the invention will become apparent as the description proceeds.

The present invention relates to a head-mountable visual accessory for displaying an image to a user from a portable display unit comprising: (a) a compartment for an image display unit; (b) at least one mirror for reflecting an image from said display unit; (c) adjustment means for adjusting the reflection of said image from said display unit to the eye of said user; (d) a structure for holding said at least one mirror, and said adjusting means for reflecting said image to said eye of the user of said visual accessory.

Preferably, the invention further comprises means for strapping said visual accessory to the head of the user.

Preferably, the invention further comprises an application running on the portable display unit for displaying an image on the display of said display unit.

In one embodiment, the head-mounted visual accessory also acts as a bicycle helmet.

In one embodiment, the head-mounted visual accessory also acts as a motorcycle helmet.

In one embodiment, the invention comprises 2 mirrors.

In one embodiment, the invention comprises 3 mirrors.

In one embodiment, the invention comprises 4 mirrors.

In one embodiment, the adjustment means are part of the construction which holds the mirror.

In one embodiment, the adjustment means are part of the application.

In one embodiment, the adjustment means are used to adjust the portable display unit position in the compartment of said portable display unit.

Preferably, the portable display unit may be operable within its compartment.

Preferably, the mirror is a magnifying mirror.

Preferably, the mirror is a transparent mirror.

Preferably, the mirror is foldable.

In one embodiment, the mirror is encapsulated in a glass structure.

In one embodiment, the mirror is encapsulated in a Lucite acrylic structure.

### BRIEF DESCRIPTION OF THE DRAWINGS

The accompanying drawings, and specific references to their details, are herein used, by way of example only, to illustratively describe some of the embodiments of the invention.

In the drawings:

FIG. 1 is a diagram of a side view of the visual accessory mounted on the head of a user, according to an embodiment of the invention.

FIG. 2 is a diagram of a portable display unit which may be held in the visual accessory, according to an embodiment of the invention.

FIG. 3 is diagram of a possible use of the visual accessory, according to an embodiment of the invention.

FIG. 4 is diagram of a magnifying mirror and other parts which may be used for the visual accessory, according to an embodiment of the invention.

FIG. 5 is a diagram of a side view of the visual accessory as a bicycle helmet, according to an embodiment of the invention.

FIG. 6a is a diagram of a side view of the visual accessory, according to an embodiment of the invention.

FIG. 6b is a diagram of a back view of the visual accessory, according to another embodiment of the invention.

FIG. 6c is a diagram of a back view of the visual accessory, according to another embodiment of the invention.

FIG. 6d is a diagram of a side view of the visor of the visual accessory, according to another embodiment of the invention.

FIG. 6e is a diagram of a back view of the visual accessory, according to another embodiment of the invention.

FIG. 7a is a diagram of an isometric side view of the visual accessory as a motorcycle helmet, according to an embodiment of the invention.

FIG. 7b is a diagram of the inside of the transparent visor shield 299, according to an embodiment of the invention.

FIG. 7c is a diagram of a side view of the visual accessory as a motorcycle helmet, according to an embodiment of the invention.

FIG. 7d is a diagram of an inside view of the visual accessory as a motorcycle helmet, according to an embodiment of the invention.

FIG. 8 is a diagram of a side view of the visual accessory mounted on the head of a user, according to another embodiment of the invention.

FIG. 9 is an explanatory diagram of the reflective affect, from the portable display unit to the user's eye, of the visual accessory, according to an embodiment of the invention.

FIG. 10 is a sketch diagram of the visual accessory, from a bottom view, according to an embodiment of the invention.

FIG. 11 is a diagram of a front view of the visual accessory held on the side of the head of a user, according to an embodiment of the invention.

FIG. 12 is diagram of the visual accessory intended for wearing on the side of the head, according to an embodiment of the invention.

FIG. 13 is diagram of the visual accessory intended for wearing on the side of the head with another panel, according to an embodiment of the invention.

FIG. 14a is a diagram of the visual accessory as a cellular phone case with unfolded mirrors, according to an embodiment of the invention.

FIG. 14b is a diagram of the visual accessory as a cellular phone case with folded mirrors, according to an embodiment of the invention.

### DETAILED DESCRIPTION

The terms of “front”, “rear”, “down”, “up”, “bottom”, “upper”, “horizontal”, “vertical”, “right”, “left” or any reference to sides or directions are used throughout the description for the sake of brevity alone and are relative terms only and not intended to require a particular component orientation.

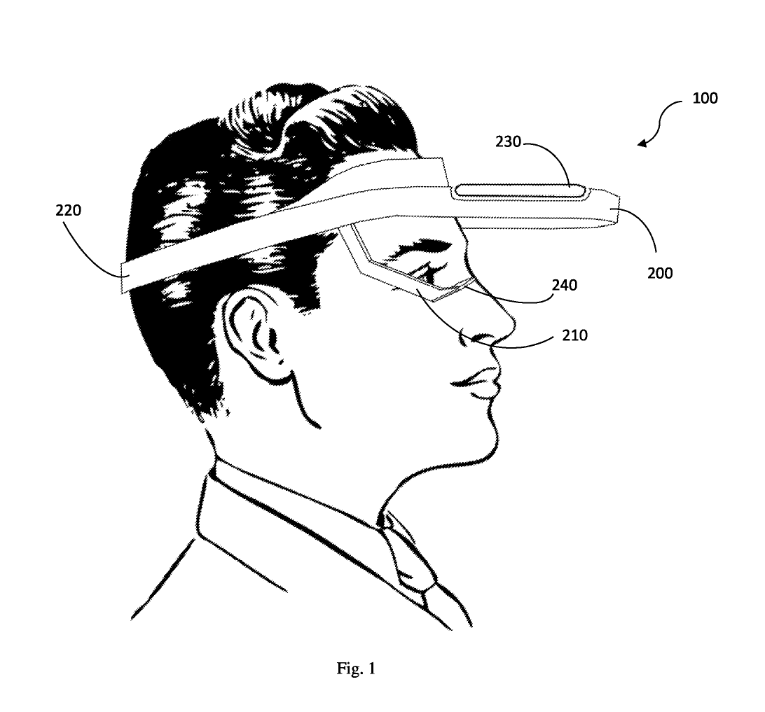

FIG. 1 is a diagram of a side view of the visual accessory mounted on the head of a user, according to an embodiment of the invention. In the diagram the user is depicted with a visual accessory 100 which is strapped to his head. The visual accessory 100 is intended to hold a portable display unit 230 and reflect at least a part of its display, i.e. an image, to the user's eye using mirror 240 implanted in the construction 210. In one embodiment, the construction 210 may be constructed to hold the mirror 240 in a certain angle as to reflect the image to the user's eye. In one embodiment the construction 210 may have adjusting means for adjusting the angle and/or position of the mirror 240 to reflect the image to the eye of the user. Thus the user may see an image from the display of his portable device 230 hands-free. In one embodiment, the visual accessory 100 may have a back-head support 220 which can be adjusted for safely holding and supporting the visual accessory 100 on the head of the user. In other embodiments the visual accessory 100 may be supported with an elastic band, a specially fit strap, a hat covering the head, or with any other mechanism that can hold and support the visual accessory 100. In one embodiment, the visor part 200 may have a compartment for holding the portable display unit 230, which may be a cellphone, a smartphone, a tablet, a phablet, a wearable smart watch or any other portable unit capable of displaying an image. The compartment may be designed for a specific portable unit such as a smartphone having certain known dimensions or the compartment may be designed for holding a number of portable units having different dimensions. The compartment may be designed as a simple cavity within the visor for placing the portable unit 230 within or the compartment may be designed for holding the portable unit 230 safely, for example by using straps or tight-fit edges or clappers, or any other compartment for placing a portable unit. The compartment may be elastic or rigid or a combination thereof.

In one of the embodiments the mirror 240 may be a transparent mirror, which may allow the user to view the scenery around him and view the image from the portable device at the same time.

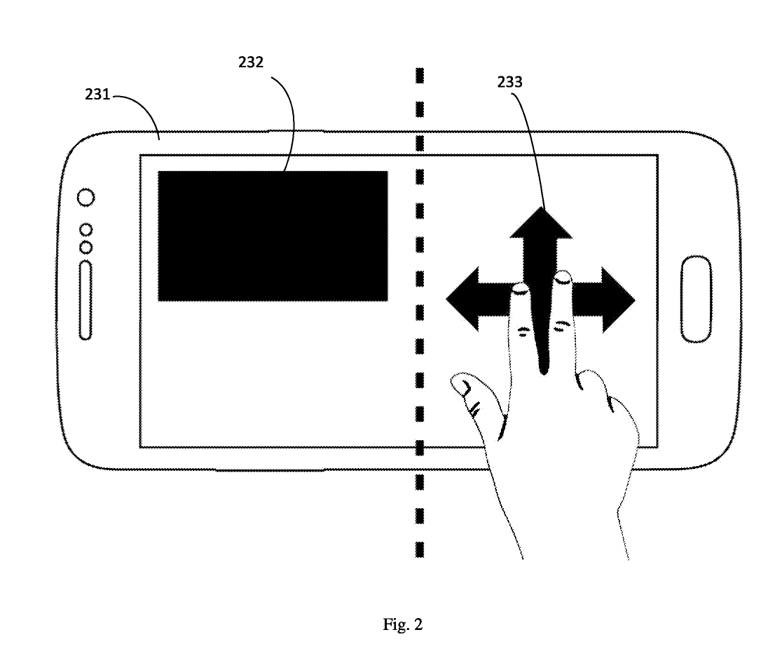

FIG. 2 is a diagram of a portable display unit which may be held in the visual accessory, according to an embodiment of the invention. Display unit 231 may be a smartphone running an application which can adjust the screen to display an image 232 intended for displaying to the user using the visual accessory. For example, the application may limit the size of the image to a part of the screen and/or flip the image to “mirror” like display. In one embodiment the display unit may allow further operation of the user in another part of the display, where the image is not displayed, such as in part 233. For example, the operation of the user may be similar to operations used on a touch screen of a smartphone. In one embodiment the visual accessory may have a designated hole or holes for allowing the user to operate the display unit 231 while it is held within the visual accessory.

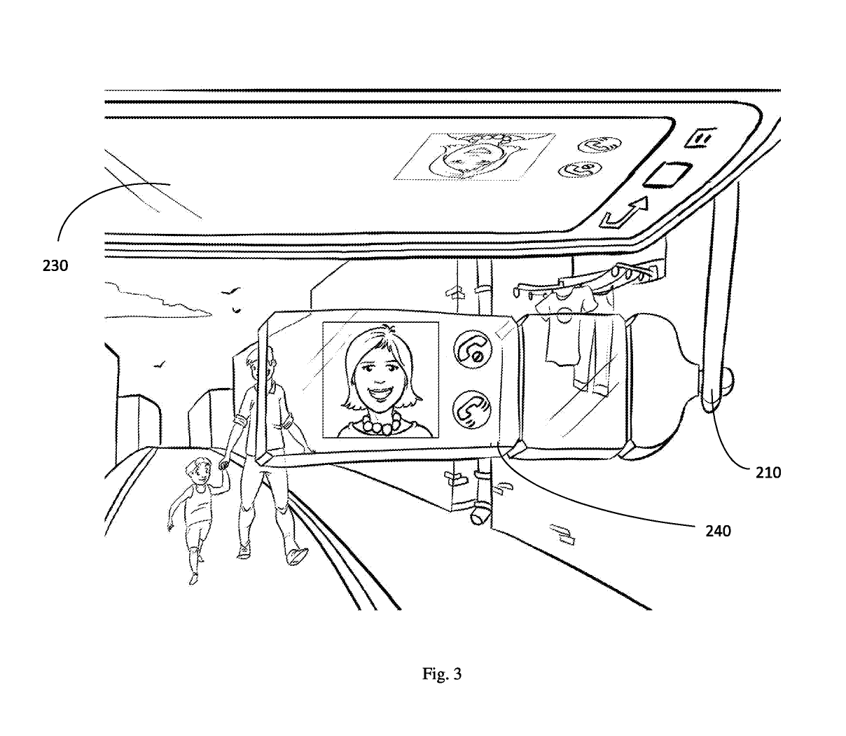

FIG. 3 is diagram of a possible use of the visual accessory, according to an embodiment of the invention. In the diagram, the portable display unit 230 is held in the visor above the user's head as described in details in relations to FIG. 1. A mirror 240 is held by the construction 210 as to reflect an image from the portable display unit 230 to the user's eye. In this embodiment the depicted mirror 240 is a transparent mirror which allows the user to view the scenery around him and view the image from the portable device simultaneously. The creation of a transparent mirror, which can have a certain degree of transparency, is well known in the art and may be constructed by attaching a film or a spray to the surface of a transparent glass, or any other known teleprompt glass may be used as well.

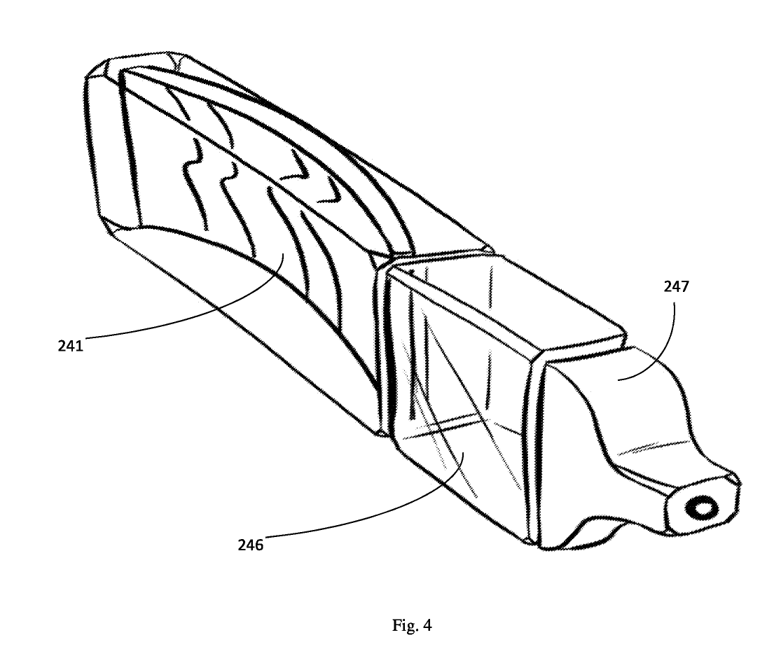

FIG. 4 is diagram of a magnifying mirror and other parts which may be used for the visual accessory, according to an embodiment of the invention. The magnifying mirror 241, which may be a concave spherical mirror, may be used for magnifying the image from a portable display unit to the user's eye.

Different magnifying mirrors may be used for reflecting a magnified image such as a mirror that magnifies ×5, or ×10, or ×20. In some of the embodiments, any mirror which can magnify between ×5 and ×20 may be used. In one embodiment the magnifying mirror itself may have different magnifying properties such as greater magnifying properties in its center. Thus the reflected image may be enlarged to the user's eye. Part 247 may be used for adjusting the angle and/or position of the mirror 241 as described in relations to FIG. 3. In one embodiment a see through extension part 246 may be added in order to better place the mirror 241 in relations to the wearer's eye. In one embodiment the mirror 241 may be encapsulated in a glass structure. In another embodiment the mirror 241 may be encapsulated in a Lucite acrylic structure or any other transparent structure. In one embodiment the structure encapsulating the mirror 241 may be a rectangular structure or a cylindrical structure or any other geometrical structure.

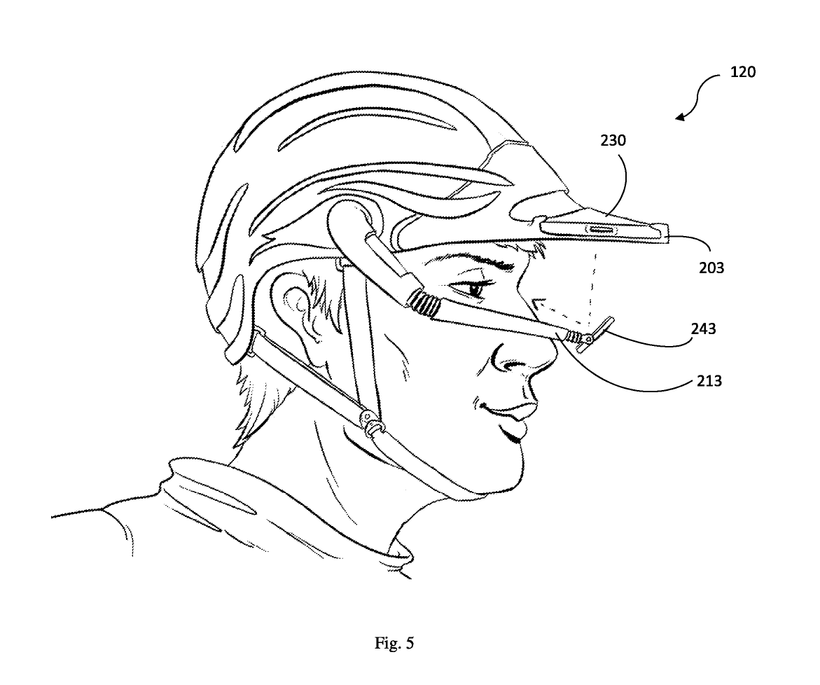

FIG. 5 is a diagram of a side view of the visual accessory as a bicycle helmet, according to an embodiment of the invention. In the diagram the visual accessory is depicted as a bicycle helmet 120 mounted on the head of a bicycle rider. The visual accessory 120 is intended to hold a portable display unit 230 and project an image to the user's eye using mirror 243 implanted in the construction 213. In one embodiment, the construction 213 may be constructed to hold the mirror 243 in a certain angle as to reflect the image to the user's eye. In one embodiment the construction 213 may have adjusting means for adjusting the angle and/or position of the mirror 243 to reflect the image to the eye of the user. Thus the user may see an image from the display of his portable device 230 hands-free, e.g. while riding a bicycle. In one embodiment the mirror 243 may be a magnifying mirror. In one embodiment, the visual accessory 120 may have adjusting means like a typical bicycle helmet for adjusting the visual accessory 120 to the head of the rider. In one embodiment, the visor part 203 may have a compartment for holding the portable display unit 230. The compartment may be designed for a specific portable unit such as a smartphone having certain known dimensions or the compartment may be designed for holding a number of portable units having different dimensions. The compartment may be designed as a simple cavity within the visor for placing the portable unit 230 within or the compartment may be designed for holding the portable unit 230 safely, for example by using straps or tight-fit edges or clappers, or any other compartment for placing a portable unit. The compartment may be elastic or rigid or a combination thereof.

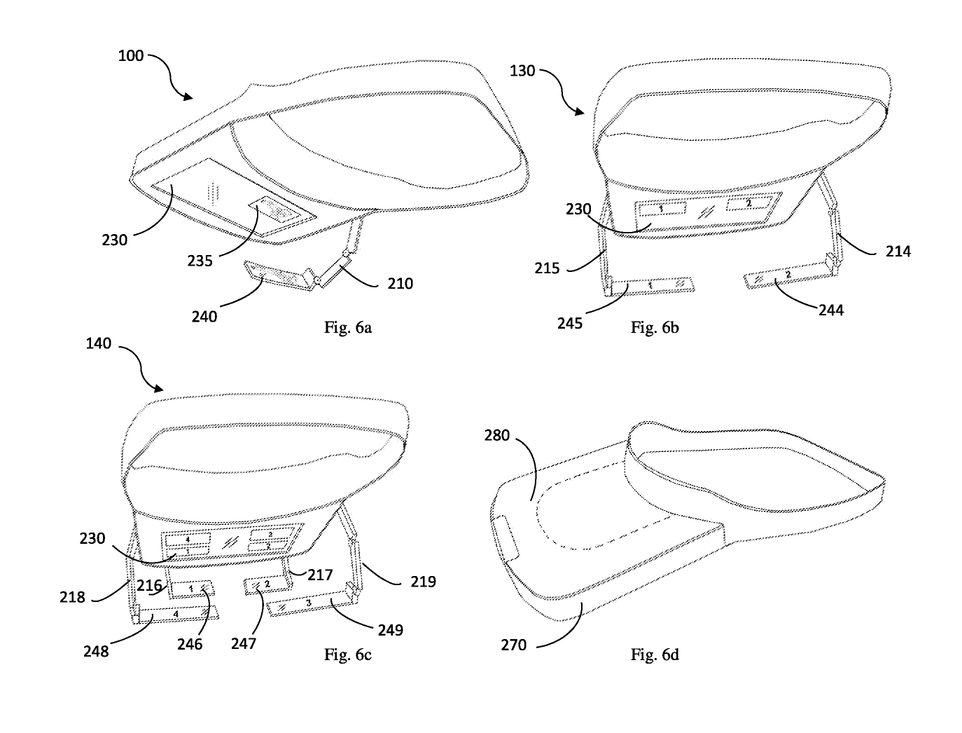

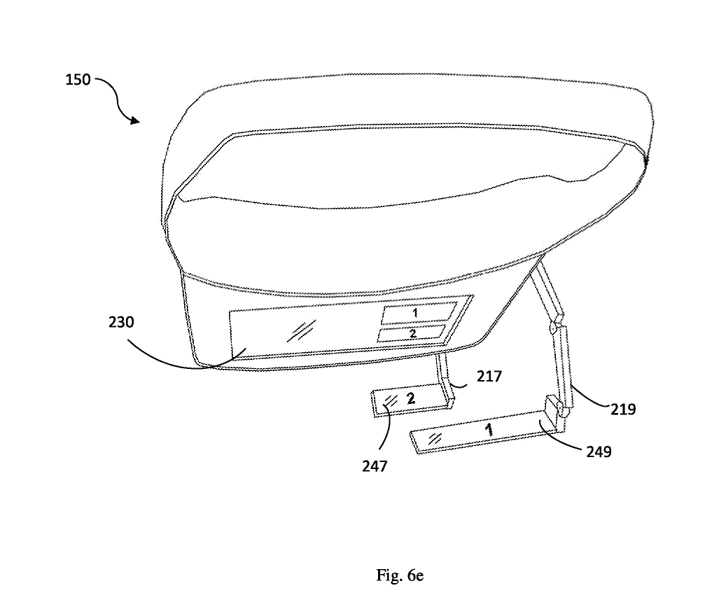

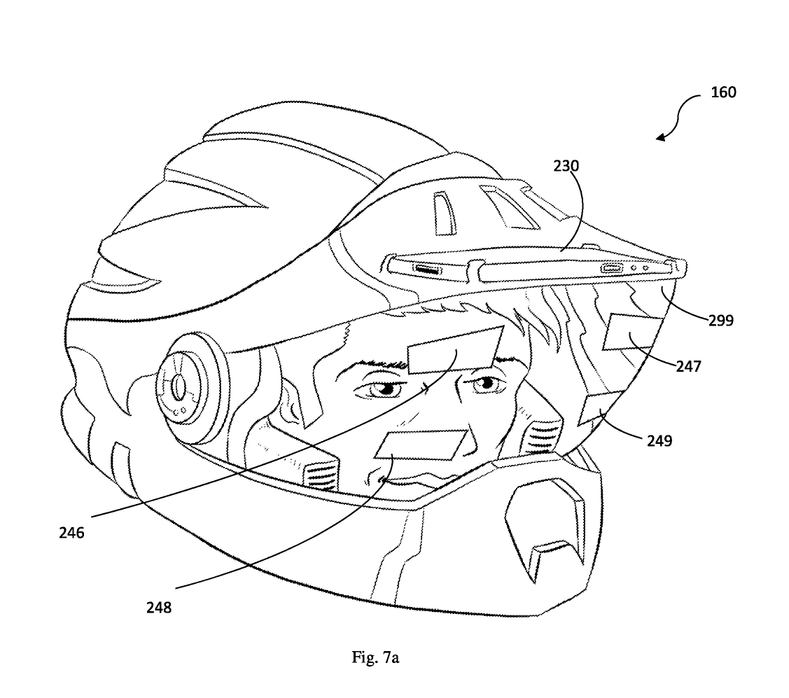

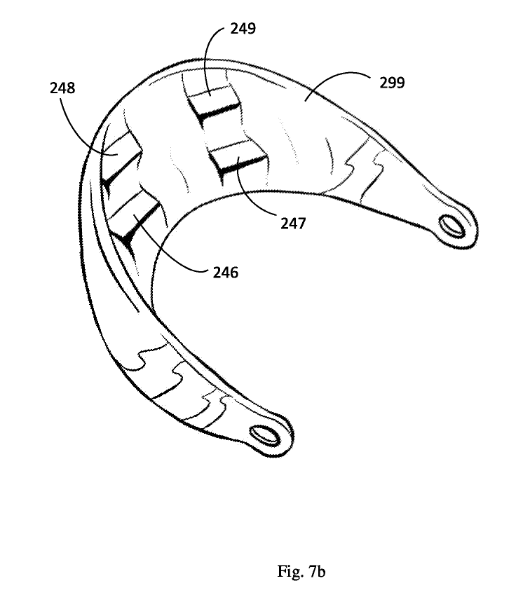

FIG. 6a is a diagram of a side view of the visual accessory, according to an embodiment of the invention. As described in relations to FIG. 1 the visual accessory 100 is intended to hold a portable display unit 230 and project an image 235 to the user's eye using mirror 240 implanted in the construction 210. In one embodiment the mirror 243 may be a magnifying mirror. In one embodiment, the construction 210 may be constructed to hold the mirror 240 as to reflect the image 235 to the user's eye. In one embodiment the construction 210 may have adjusting means, such as joints and/or hinges, for adjusting the angle and/or position of the mirror to reflect the image 235 to the eye of the user. Thus the user may see the image 235 from the display of his portable device 230 hands-free.

In one embodiment the construction 210 may be a foldable construction. In one embodiment the construction 210 may be folded into the visual accessory 100. Thus the user may unfold the construction 210 in order to see the image 235, from the display of his portable device 230 hands-free, and fold the construction 210 back into the visual accessory 100.

FIG. 6b is a diagram of a back view of the visual accessory, according to another embodiment of the invention. As described in relations to FIG. 6a the visual accessory 130 is intended to hold a portable display unit 230. However, in this embodiment the visual accessory 130 is intended to project 2 images to the user's eyes using 2 mirrors 244 implanted in the construction 214, and 245 implanted in the construction 215. In one embodiment, each of the constructions 214 and 215 may be constructed to hold each of the mirrors 244 and 245 respectively in certain angles as to reflect the images to the user's eyes. In one embodiment each of the constructions 214 and 215 may each have separate adjusting means for adjusting the angle and/or position of each of the mirrors to reflect the images to the eyes of the user. Thus the user may see 2 images from the display of his portable device 230 hands-free.

FIG. 6c is a diagram of a back view of the visual accessory, according to another embodiment of the invention. As described in relations to FIG. 6b the visual accessory 140 is intended to hold a portable display unit 230. However, in this embodiment the visual accessory 140 is intended to project 4 images to the user's eyes using 4 mirrors 246-249 implanted in the construction 216-219, respectively. In one embodiment, each of the constructions 216-219 may be constructed to hold each of the mirrors 246-249 respectively in certain angles as to reflect the images to the user's eyes. In one embodiment, one or more of the mirrors 246-249 may be a magnifying mirror. In one embodiment each of the constructions 216-219 may each have separate adjusting means for adjusting the angle and/or position of each of the mirrors to reflect the images to the eyes of the user. Thus the user may see 4 images from the display of his portable device 230 hands-free.

FIG. 6d is a diagram of a side view of the visor of the visual accessory, according to another embodiment of the invention. In one embodiment, the visor part 270 may have a compartment for holding the portable display unit. The compartment may be designed for a specific portable unit having certain known dimensions or the compartment may be designed for holding a number of portable units having different dimensions. The compartment may have a lid 280 for closing over the portable display unit. The lid may be magnetically fastened, or fastened by any other fastening method, over the portable display unit. The lid and/or visor may be elastic or rigid or a combination thereof.

FIG. 6e is a diagram of a back view of the visual accessory, according to another embodiment of the invention. As described in relations to FIG. 6b the visual accessory 150 is intended to hold a portable display unit 230. However, in this embodiment the visual accessory 150 is intended to project the 2 images to one of the user's eyes using 2 mirrors 249 implanted in the construction 219, and 247 implanted in the construction 217. In one embodiment, one or both of the mirrors 249 and 247 may be a magnifying mirror. In one embodiment, each of the constructions 219 and 217 may be constructed to hold each of the mirrors 249 and 247 respectively in certain angles as to reflect the images to the user's eyes. In one embodiment each of the constructions 219 and 217 may each have separate adjusting means for adjusting the angle and/or position of each of the mirrors to reflect the images to the eyes of the user. Thus the user may see 2 images from the display of his portable device 230 hands-free.

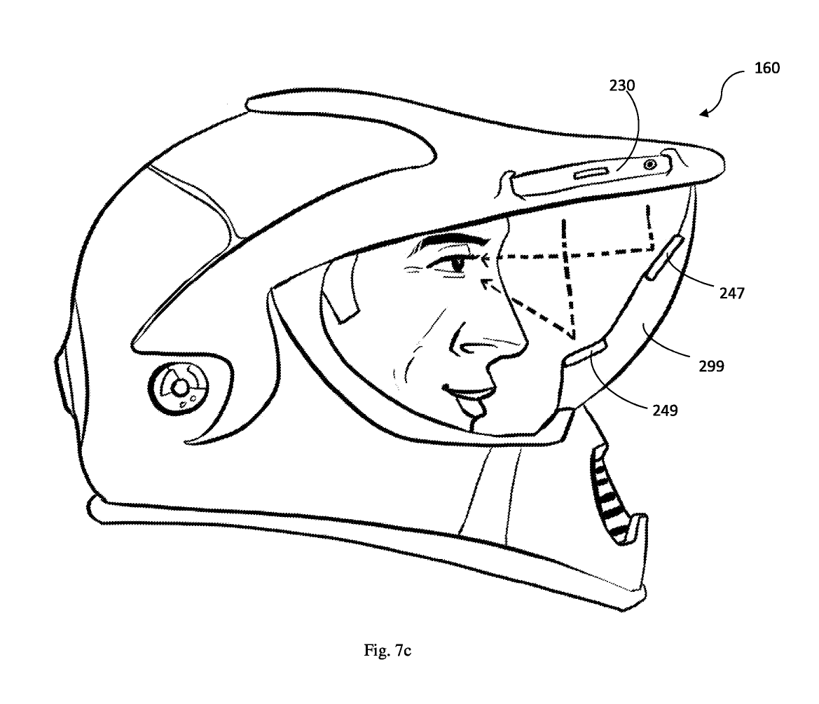

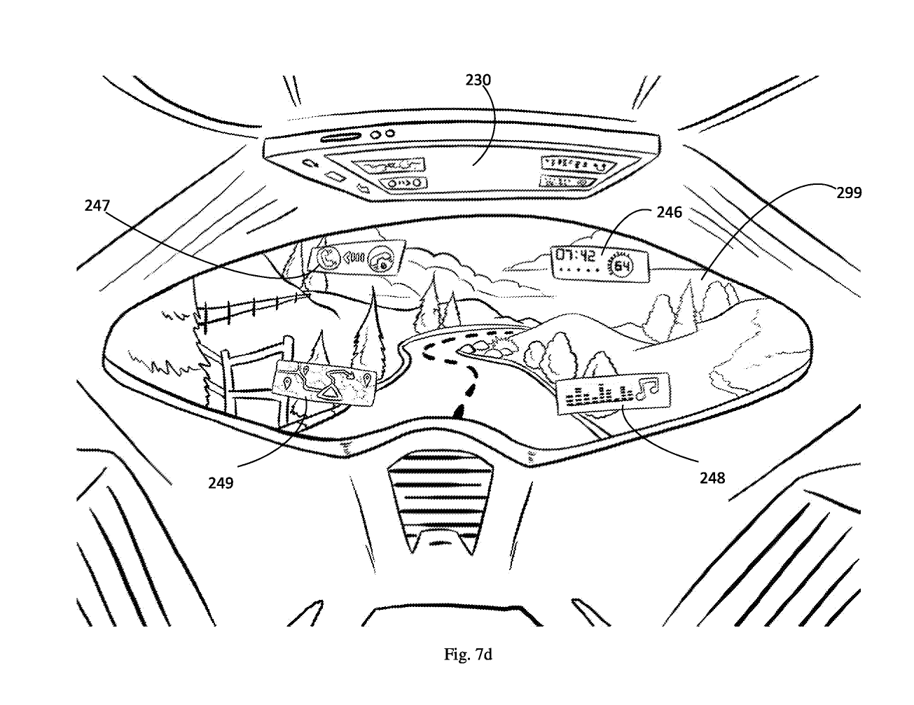

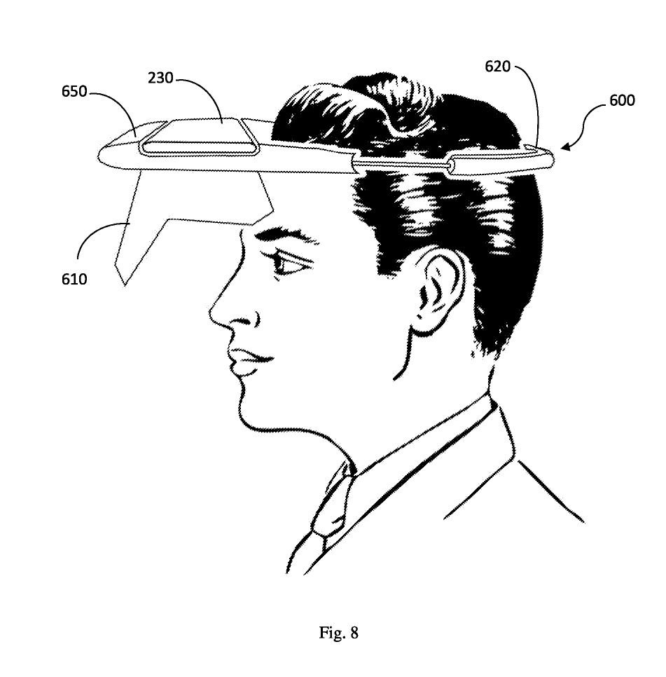

FIG. 7a is a diagram of an isometric side view of the visual accessory as a motorcycle helmet, according to an embodiment of the invention. As described in relations to FIG. 6c the visual accessory 160 is intended to hold a portable display unit 230. However, in this embodiment instead of the constructions, which hold the mirrors, the mirrors are placed on the transparent visor shield 299 of the visual accessory 160. The visual accessory 160 may be intended to project 4 images to the user's eyes using the 4 mirrors 246-249 implanted in the transparent visor shield 299 of the visual accessory 160. Thus the user may see 4 images from the display of his portable device 160 hands-free. In one embodiment, the visual accessory 160 may be intended to project only 2 images to the user's eyes, e.g. by using only the 2 mirrors 246 and 248 implanted in the transparent visor shield 299 of the visual accessory 160. In another embodiment, the visual accessory 160 may be intended to project only 1 images to the user's eyes, e.g. by using only the mirror 248 implanted in the transparent visor shield 299 of the visual accessory 160. In one embodiment, one or more of the mirrors 246-249 may be a magnifying mirror. In one embodiment, one or more of the mirrors 246-249 may be a transparent mirror.

FIG. 7b is a diagram of the inside of the transparent visor shield 299, according to an embodiment of the invention. As described in relations to FIG. 7a the visor shield 299 is intended to hold the 246-249. The 246-249 may be placed, glued, superimposed, molded, and/or cast in the transparent visor shield 299, or any other way implemented on the transparent visor shield 299 in order to reflect the images from the portable display unit to the user's eye.

FIG. 7c is a diagram of a side view of the visual accessory as a motorcycle helmet, according to an embodiment of the invention. As described in relations to FIG. 7a the visual accessory 160 is intended to hold a portable display unit 230 and the mirrors are placed on the transparent visor shield 299 of the visual accessory 160. Thus the mirrors, such as mirrors 249 or 247, may reflect the images from the portable display unit 230 to the user's eye.

FIG. 7d is a diagram of an inside view of the visual accessory as a motorcycle helmet, according to an embodiment of the invention. As described in relations to FIG. 7a the visual accessory is intended to hold a portable display unit 230, where the mirrors are placed on the transparent visor shield 299 of the visual accessory. The visual accessory may be intended to project 4 images to the user's eyes using the 4 mirrors 246-249 implanted in the transparent visor shield 299 of the visual accessory. Thus the user may see 4 images simultaneously from the display of his portable device hands-free.

In one of the embodiments, the images displayed on the portable display unit may be moved and adjusted for the user benefit. Thus the user may adjust the images themselves on the portable display unit to fit his eyes. In another embodiment the portable display unit position and angle may be adjusted in its compartment for the user's benefit, thus, the user may adjust the portable display to reflect the image to his eye. In yet another embodiment, the user may be able to adjust the images on the display or to adjust the position of the portable display unit or to adjust the constructions holding the mirrors or a combination thereof in order to adjust the reflection of the image to his eye.

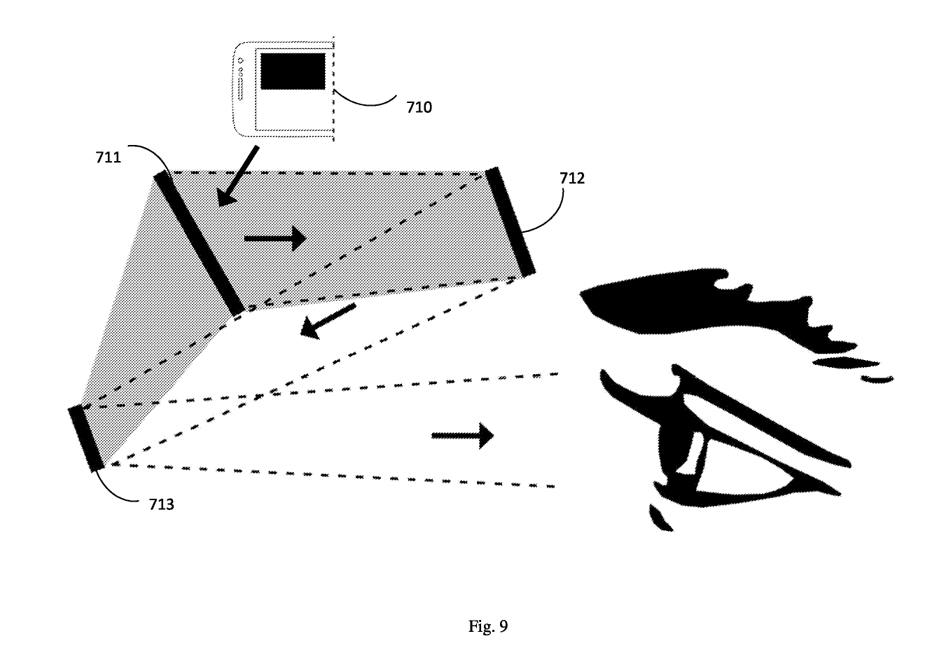

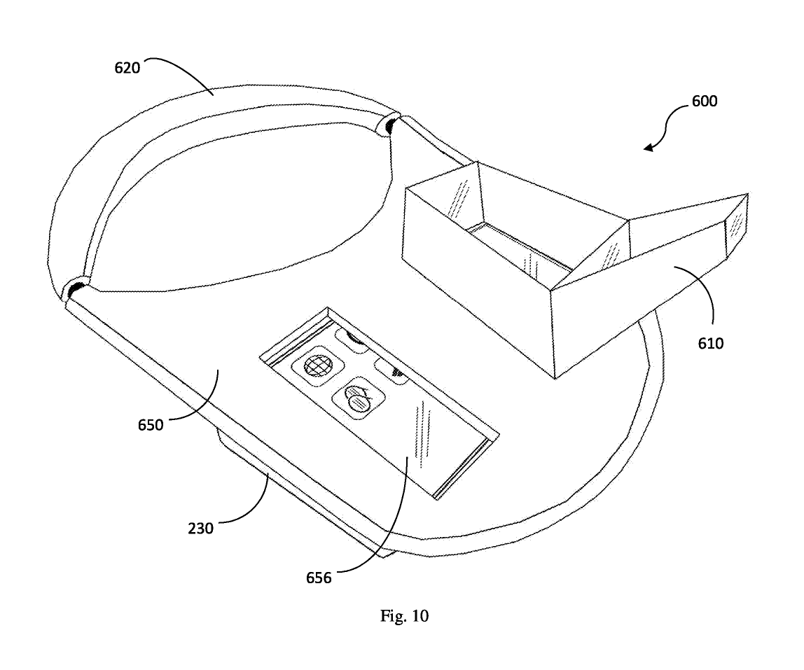

FIG. 8 is a diagram of a side view of the visual accessory mounted on the head of a user, according to another embodiment of the invention. In the diagram the user is depicted with a visual accessory 600 which is strapped to his head. The visual accessory 600 is intended to hold a portable display unit 230 and project at least a part of its display, i.e. an image, to the user's eye using 3 mirrors implanted in the special reflective construction 610, which is described further in relations to FIG. 9. Thus the user may see an image from the display of his portable device 230 hands-free. In one embodiment, the visual accessory 600 may have a back-head support 620 which can be adjusted for safely holding and supporting the visual accessory 600 on the head of the user. In other embodiments the visual accessory 600 may be supported with an elastic band, a specially fit strap, a hat covering the head, or with any other mechanism that can hold and support the visual accessory 600. In one embodiment, the visor part 650 may have a compartment for holding the portable display unit 230, which may be a cellphone, a smartphone, a tablet, a phablet, or any other portable unit. The compartment may be designed for a specific portable unit such as a smartphone having certain known dimensions or the compartment may be designed for holding a number of portable units having different dimensions. The compartment may be designed as a simple cavity within the visor for placing the portable unit 230 within or the compartment may be designed for holding the portable unit 230 safely, for example by using straps or tight-fit edges or clappers. The compartment may be elastic or rigid or a combination thereof.

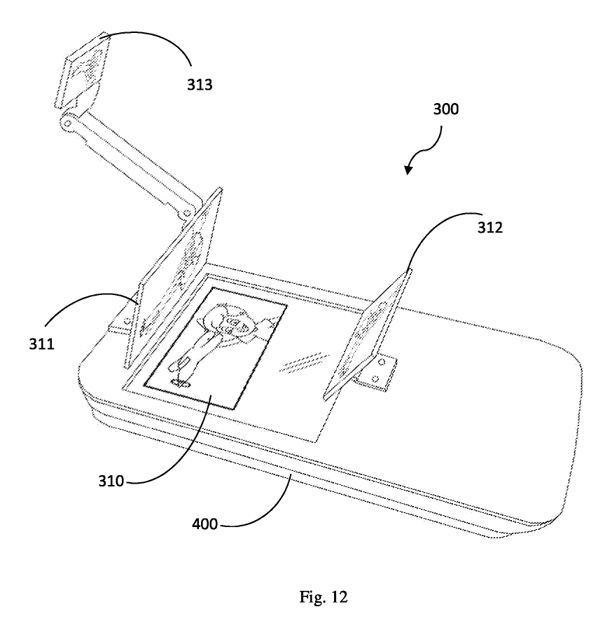

FIG. 9 is an explanatory diagram of the reflective affect, from the portable display unit to the user's eye, of the visual accessory, according to an embodiment of the invention. In the diagram, an image from the display 710 of the display unit is reflected by mirror 711 to mirror 712, which is reflected again to the mirror 713, which further reflects the image to the user's eye. Thus the user can see an image from the display unit 710 where the reflecting distance between the mirrors can cause the eye of the user to perceive the image as originating from a comfortable distance. In addition, due to the physical characteristics, which will be described further in relations to FIG. 12, of reflective optics which requires a smaller mirror for viewing a full image, the mirrors may be set in a descending order where the first mirror 711 can be smaller than the displayed area of the image, and the second mirror 712 which may be smaller than the first mirror 711, and the third mirror 713 may be smaller than the second mirror 212.

In one of the embodiments the third mirror 713 may be a transparent mirror, which may allow the user to view the scenery around him and view the image from the portable device at the same time.

FIG. 10 is a sketch diagram of the visual accessory, from a bottom view, according to an embodiment of the invention. The visor part 650, of the visual accessory 600 described in relations to FIG. 8, may have a compartment for holding an image display unit 230. The image display unit may be held with its screen facing the reflective construction 610. In this embodiment only part of the display is displayed to the reflective construction 610. In one embodiment an application may be run on the image display unit for adjusting the image displayed on the display to fit certain dimensions relating to the reflective construction 610. The image may be displayed to the eye of the wearer using the reflective construction 610 as described in relations to FIG. 9. In addition, the visor 650 may have a hole 656 for operating the image display unit 230. The visual accessory 600 may have the back-head support 620 which can be adjusted for safely holding and supporting the visual accessory 600 on the head of the user.

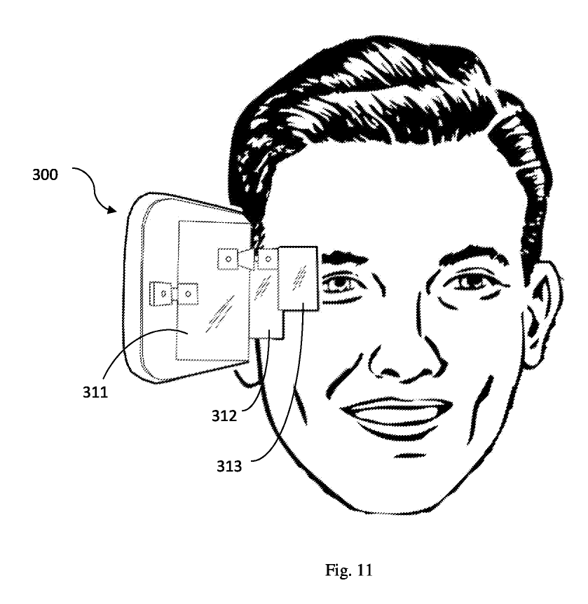

FIG. 11 is a diagram of a front view of the visual accessory held on the side of the head of a user, according to an embodiment of the invention. In the diagram, the user is depicted with a visual accessory 300 which is held to the side of his head. In this embodiment, the visual accessory 300 reflects an image from the display to the side of the eye of the user. The reflection may be done using a number of mirrors such as mirrors 311, 312, and 313. In one embodiment, The visual accessory 300 may be strapped to the user's head using a head strap or any other means. When the visual accessory 300 is held to the side of the head it may be placed about the blind spot of the eye to reduce any discomforts the user may feel with the visual accessory 300. For example, the visual accessory 300 may be held where the mirror 313 is positioned about the blind spot of the right eye, thus, the user won't be bothered by the image reflected in mirror 313 until he shifts his eye sight to look at the display in mirror 313. In this way the user may wear the visual accessory 300 and revert to the displayed image when desired.

FIG. 12 is diagram of the visual accessory intended for wearing on the side of the head, according to an embodiment of the invention. The visual accessory 300 may have 3 mirrors 311, 312, 313 as described in relations to FIG. 11. The image 310 from the display unit may be reflected by mirror 311 to mirror 312, which is reflected to mirror 313, which can reflect the image to the user's eye. Due to the physical characteristics of reflective optics which requires, for viewing a full image, a mirror that can have a size area smaller than the image, the mirrors may be set in a descending order where the first mirror 311 can have the area size of less than the area size of the image, and the second mirror 312 may have the area size less than the first mirror 311, and the third mirror 313 may have the area size of less than the second mirror 312.

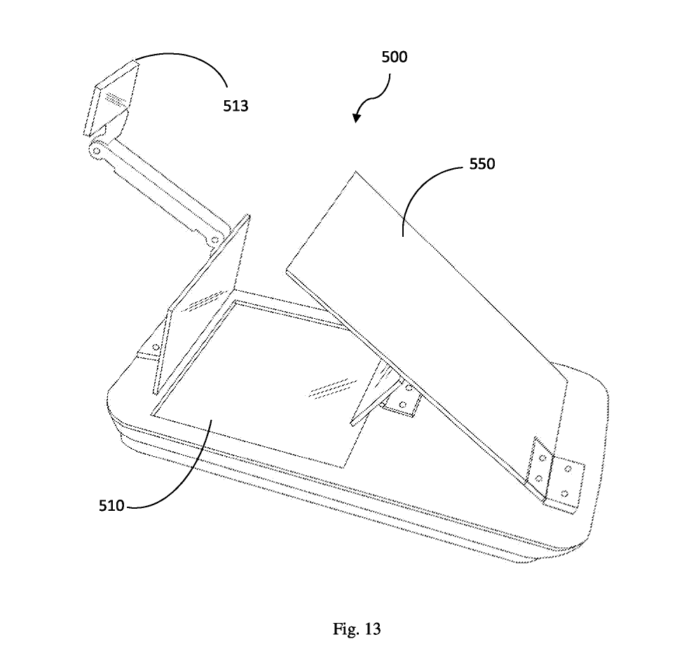

FIG. 13 is diagram of the visual accessory intended for wearing on the side of the head, according to an embodiment of the invention. The depicted visual accessory 500 is similar to the visual accessory 300 described in relations to FIG. 12, however, visual accessory 500 may also have another panel 550 which may be used for blocking the direct view from the eye, of the wearer, to the display 510. This panel 550 may be used to allow the user a clear view of the mirror 513, which displays the image, without “side” interferences from the display 510.

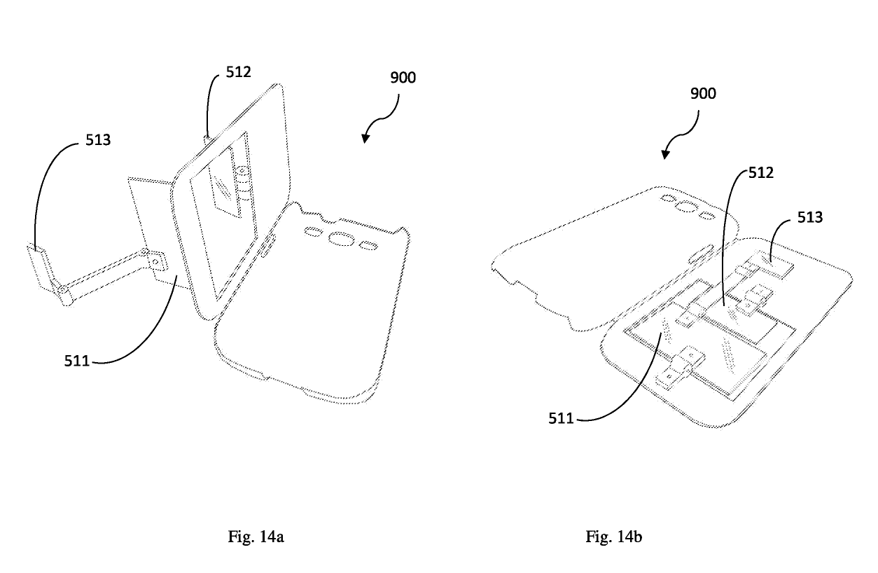

FIGS. 14a and 14b are diagrams of the visual accessory as a cellular phone case, according to an embodiment of the invention. In this embodiment the visual accessory 900 may be used as a protective gear for a visual display unit where the mirrors 511, 512, and 513 may be folded as depicted in FIG. 14b. Thus when the mirrors are folded, as depicted in FIG. 14b, the display unit and its protective visual accessory may be carried in a pocket or a bag. Nevertheless, when the user wishes to use the visual accessory he may open the mirrors as depicted in FIG. 14a and use the visual accessory for viewing images from the display unit.

While the above description discloses many embodiments and specifications of the invention, these were described by way of illustration and should not be construed as limitations on the scope of the invention. The described invention may be carried into practice with many modifications which are within the scope of the appended claims.

1. A head-mountable visual accessory for displaying an image to a user from a portable display unit comprising:
a compartment for an image display unit;
at least one mirror for reflecting an image from said display unit;
adjustment means for adjusting the reflection of said image from said display unit to the eye of said user;
a structure for holding said compartment, said at least one mirror, and said adjusting means for reflecting said image to said eye of said user of said visual accessory.

2. The visual accessory according to claim 1, further comprising means for strapping said visual accessory to the head of the user.

3. The visual accessory according to claim 1, further comprising an application running on the portable display unit for displaying an image on the display of said display unit.

4. The visual accessory according to claim 1, where the head-mounted visual accessory also acts as a bicycle helmet.

5. The visual accessory according to claim 1, where the head-mounted visual accessory also acts as a motorcycle helmet.

6. The visual accessory according to claim 5, where there are 2 or more curved surfaces in the visor of the motorcycle helmet for magnifying the image projected from within the helmet.

7. The visual accessory according to claim 1, comprising 3 mirrors.

8. The visual accessory according to claim 1, comprising 4 mirrors.

9. The visual accessory according to claim 1, where the adjustment means are part of the construction which holds the mirror.

10. The visual accessory according to claim 1, where the adjustment means are part of the application.

11. The visual accessory according to claim 1, where the adjustment means are used to adjust the portable display unit position in the compartment of said portable display unit.

12. The visual accessory according to claim 1, where the portable display unit may be operable within its compartment.

13. The visual accessory according to claim 1, where the mirror is a magnifying mirror.

14. The visual accessory according to claim 1, where the mirror is a transparent mirror.

15. The visual accessory according to claim 1, where the construction that holds the mirror is foldable.

16. The visual accessory according to claim 1, where the mirror is encapsulated in a glass structure or acrylic structure.

17. (canceled)

18. The visual accessory according to claim 1, comprising 2 mirrors side by side.

19. The visual accessory according to claim 1, comprising 2 mirrors one above the other.
